(19) United States
(12) Patent Application Publication
(10) Pub. No.: US 2026/0242518 A1
(43) Pub. Date: Aug. 20, 2026

(54) SILANOL FUNCTIONAL POLYOLEFINS

(71) Applicant: Dow Global Technologies LLC, Midland, MI (US)

(72) Inventors: Zachary S. Kean, Bay City, MI (US); Ryan Maar, Midland, MI (US); John Roberts, Midland, MI (US); Jin Wang, Midland, MI (US); David S. Laitar, Midland, MI (US); Shudi Lai, Phoenix, AZ (US)

(21) Appl. No.: 19/469,438

(22) PCT Filed: Sep. 27, 2024
(86) PCT No.: PCT/US2024/048872

§ 371 Date: Sep. 26, 2025

Related U.S. Application Data
(60) Provisional application No. 63/540,795, filed on Sep. 27, 2023.

(51) Int. Cl. C08F 8/06

(52) U.S. Cl. CPC C08F 8/06

(57) ABSTRACT

Embodiments of the present disclosure are directed towards a method of preparing a silanol-functional polyolefin that includes combining, under thermal conditions to effect synthesis of a silanol moiety, starting materials comprising A) a silyl hydride-functionalized polyolefin, optionally B) a solvent, C) a peroxy acid, optionally D) a neutralizing agent thereby forming a reaction mixture that under the thermal conditions produces the silanol-functional polyolefin having the silanol moiety.

### FIELD OF DISCLOSURE

Embodiments of the present disclosure are directed to polyolefins and more particularly to silanol functional polyolefins.

### BACKGROUND

The synthesis of polar polyolefins is a longstanding problem for at least some of the following reasons. Polar comonomers can be copolymerized with ethylene monomers, however this is a capital intensive high pressure process and the resulting polymers have extensive branching and other property/composition limitations. Radical grafting can be performed on high density polyethylene or linear low density polyethylene polymers, but the scope of graftable monomers is limited and a heterogeneous mixture of graft points and lengths (e.g., mono, oligo, polygrafts) is all that can usually be obtained. In addition, commercial in-reactor solution phase polyolefin synthesis is unable to tolerate polar monomers due to their incompatibility with the catalysts.

In another approach, silane (—SiH) functional groups can be incorporated “in-reactor” and are compatible with conventional catalysts but are non-polar and require additional reaction to give polar functionality. The simplest reaction of —SiH to give polar functionality is through oxidation or hydrolysis to give SiOH (silanol). However, silanols are difficult to synthesize in a controlled manner without further condensation to Si—O—Si. Transition-metal compounds can also be used (e.g., Pd, Ru, Ir, Cr, and Rh), but these compounds are expensive and need to be separated from the final reaction product, which is also problematic. Additionally, several methods for silane hydrolysis have been reported using stoichiometric oxidants such as dioxiranes and potassium permanganate. Unfortunately, dioxiranes are unstable and not suitable for temperatures required for polyolefin functionalization and potassium permanganate is costly, highly colored and difficult to remove from the final product. It is therefore desirable to develop alternate, ideally in-reactor approaches to the synthesis of polar polyolefins that does not include these shortcomings.

### SUMMARY

The present disclosure provides various embodiments, including addressing the above shortcomings by providing a method of preparing a silanol-functional polyolefin that includes combining, under thermal conditions to effect synthesis of a silanol moiety, starting materials that include A) a silyl hydride-functionalized polyolefin, optionally B) a solvent, C) a peroxy acid, and optionally D) a neutralizing agent thereby forming a reaction mixture that under the thermal conditions produces the silanol-functional polyolefin having the silanol moiety. As disclosed herein, the silyl hydride-functionalized polyolefin can include a silyl hydride moiety of Formula I:

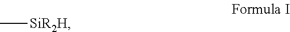

(e.g., includes the silyl hydride moiety of Formula I) where each R is independently selected from the group consisting of alkyl groups of 1 to 4 carbon atoms and aryl groups of 6 to 10 carbon atoms. As disclosed herein, each R can be a methyl group (e.g., each R is a methyl group). In addition, as disclosed herein the silyl hydride-functionalized polyolefin can include 0.10 weight percent (wt. %) to 10 wt. % of the silyl hydride moiety of Formula I based on the total weight of the silyl hydride-functionalized polyolefin (e.g., the silyl hydride-functionalized polyolefin includes 0.10 wt. % to 10 wt. % of the silyl hydride moiety of Formula I based on the total weight of the silyl hydride-functionalized polyolefin). In specific embodiments, the silyl hydride-functionalized polyolefin can be selected from the group consisting of a silyl hydride-functionalized polyethylene and a silyl hydride-functionalized polypropylene (e.g., the silyl hydride-functionalized polyolefin is selected from the group consisting of a silyl hydride-functionalized polyethylene and a silyl hydride-functionalized polypropylene). In one embodiment, the silyl hydride-functionalized polyolefin can be a branched silyl hydride-functionalized polyolefin (e.g., the silyl hydride-functionalized polyolefin is a branched silyl hydride-functionalized polyolefin).

As disclosed herein, the thermal conditions to effect synthesis of the silanol moiety can include melt-blending the reaction mixture at a temperature of 100° C. to 180° C. for a duration from 30 seconds to 60 minutes (e.g., thermal conditions to effect synthesis of the silanol moiety includes melt-blending the reaction mixture at a temperature of 100° C. to 180° C. for a duration from 30 seconds to 60 minutes). As disclosed herein, the method can occur (e.g., occurs) in the absence of a solvent. As disclosed herein, the thermal conditions to effect synthesis of the silanol moiety includes dissolving the silyl hydride-functionalized polyolefin in B) the solvent of the reaction mixture. As disclosed herein, the thermal conditions to effect synthesis of the silanol moiety includes heating the reaction mixture at a temperature of 60° C. to 120° C. for a duration from one minute to 60 minutes. As disclosed herein, the method of the present disclosure further comprises separating the silanol-functional polyolefin from the reaction mixture.

As disclosed herein, the peroxy acid is used in the method of the present disclosure in an amount of 1 to 3 molar equivalents of peroxy acid based on silicon bonded hydrogen content of A) the silyl hydride-functionalized polyolefin. As disclosed herein, the peroxyacetic acid can be (e.g., is) selected from the group consisting of peracetic acid, meta-chloroperbenzoic acid, perbenzoic acid and combinations thereof. As disclosed herein, the neutralizing agent, D), can be (e.g., is) present in the reaction mixture. As disclosed herein, the present disclosure provides for a silanol-functional polyolefin formed by the methods disclosed herein.

### DETAILED DESCRIPTION

The following detailed description provides for, among other things, an approach (e.g., an in-reactor approach) to the synthesis of polar polyolefins. As discussed herein, the typical commercial in-reactor solution phase polyolefin synthesis is unable to tolerate polar monomers due to incompatibility with the catalysts and is therefore unable to produce polar polyolefins. And while silane (—SiH) functional groups can be incorporated “in-reactor” and are compatible with conventional catalysts, they are non-polar and require additional reactions to give polar functionality. The simplest reaction of silane to give polar functionality to a polyolefin is through oxidation or hydrolysis of the silane to form silanol (—SiOH). However, silanols are difficult to synthesize in a controlled manner without further condensation of Si—OH to Si—O—Si, which is unacceptable. In addition, while transition-metal compounds can be used (e.g., Pd, Ru, Ir, Cr, and Rh) in these processes, they are expensive and need to be separated from the final reaction product. Additionally, methods for silane hydrolysis using stoichiometric oxidants such as dioxiranes are unstable and not suitable for temperatures required for polyolefin functionalization, and those using potassium permanganate are too costly and include in highly colored and difficult to remove byproducts.

In response to the shortcomings discussed herein, embodiments of the present disclosure provide for a method of preparing a silanol-functional polyolefin that includes combining, under thermal conditions to effect synthesis of a silanol moiety, starting materials that include A) a silyl hydride-functionalized polyolefin, optionally B) a solvent, C) a peroxy acid, and optionally D) a neutralizing agent thereby forming a reaction mixture that under the thermal conditions produces the silanol-functional polyolefin having the silanol moiety.

As used herein, “optionally” means “with or without.” For example, “optionally, a solvent” means with or without a solvent.

Unless stated to the contrary, implicit from the context, or customary in the art, all parts and percents are based on weight, and all test methods are current as of the filing date of this disclosure.

As used herein, “a,” “an,” and “the,” are used following an open-ended term such as comprising to mean “at least one.” In any aspect or embodiment of the instant disclosure described herein, the term “about” in a phrase referring to a numerical value may be deleted from the phrase to give another aspect or embodiment of the instant disclosure. In the former aspects or embodiments employing the term “about,” meaning of “about” can be construed from context of its use.

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation, any other component, step or procedure, excepting those that are not essential to operability. The term “consisting of” excludes any component, step or procedure, not specifically delineated or listed.

Preferably “about” means from 90 percent to 100 percent of the numerical value, from 100 percent to 110 percent of the numerical value, or from 90 percent to 110 percent of the numerical value. In any aspect or embodiment of the instant disclosure described herein, the open-ended terms “comprising,” “comprises,” and the like (which are synonymous with “including,” “having,” and “characterized by”) may be replaced by the respective partially closed phrases “consisting essentially of,” consists essentially of,” and the like or the respective closed phrases “consisting of,” “consists of,” and the like to give another aspect or embodiment of the instant disclosure. The partially closed phrases such as “consisting essentially of” and the like limits scope of a claim to materials or steps recited therein and those that do not materially affect the basic and novel characteristic(s) of the claimed disclosure. The term “characterizable” is open-ended and means distinguishable.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus, includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers.

The term “interpolymer,” as used herein, refers to polymer prepared by the polymerization of at least two different types of monomers. The term interpolymer thus includes the term copolymer (employed to refer to polymers prepared from two different types of monomers) and polymers prepared from more than two different types of monomers (e.g., terpolymer).

The term “olefin-based polymer,” as used herein, refers to a polymer that comprises, in polymerized form, 50 wt % or a majority weight percent of an olefin, such as ethylene or propylene (based on the weight of the polymer), and optionally may comprise one or more comonomers.

The term “propylene-based polymer,” as used herein, refers to a polymer that comprises, in polymerized form, 50 wt % or a majority weight percent of propylene (based on the weight of the polymer), and optionally may comprise one or more comonomers.

The term “ethylene-based polymer,” as used herein, refers to a polymer that comprises, in polymerized form, 50 wt % or a majority weight percent of ethylene (based on the weight of the polymer), and optionally may comprise one or more comonomers.

The term “ethylene/alpha-olefin interpolymer,” as used herein, refers to a random interpolymer that comprises, in polymerized form, 50 wt % or a majority weight percent of ethylene (based on the weight of the interpolymer), and an alpha-olefin.

The term, “ethylene/alpha-olefin copolymer,” as used herein, refers to a random copolymer that comprises, in polymerized form, 50 wt % or a majority weight percent of ethylene (based on the weight of the copolymer), and an alpha-olefin, as the only two monomer types.

The term “propylene/alpha-olefin interpolymer,” as used herein, refers to a random interpolymer that comprises, in polymerized form, 50 wt % or a majority weight percent of propylene (based on the weight of the interpolymer), and an alpha-olefin.

The term, “propylene/alpha-olefin copolymer,” as used herein, refers to a random copolymer that comprises, in polymerized form, 50 wt % or a majority weight percent of propylene (based on the weight of the copolymer), and an alpha-olefin, as the only two monomer types.

The term “silyl hydride-functionalized polyolefin,” as used herein, refers to a random interpolymer that comprises, in polymerized form, 50 wt % or a majority weight percent of an olefin (based on the weight of the interpolymer), and a silane monomer. As used herein, the interpolymer comprises at least one Si—H group, and the phrase “at least one Si—H group” refers to a type of “Si—H” group. It is understood in the art that the interpolymer would contain a multiple number of these groups. The silyl hydride-functionalized polyolefin is formed by the copolymerization (for example, using a bis-biphenyl-phenoxy metal complex) of at least the olefin (e.g., ethylene and/or propylene) and the silane monomer, as provided herein. An example of a silane monomer is depicted in Formula 1, as described herein.

The term “ethylene/silane interpolymer,” as used herein, refers to a random interpolymer that comprises, in polymerized form, 50 wt % or a majority weight percent of ethylene (based on the weight of the interpolymer), and a silane monomer. As used herein, the interpolymer comprises at least one Si—H group, and the phrase “at least one Si—H group,” as discussed above. The ethylene/silane interpolymer is formed by the copolymerization of at least the ethylene and the silane monomer.

The term “ethylene/alpha-silyl hydride-functionalized polyolefin,” as used herein, refers to a random interpolymer that comprises, in polymerized form, 50 wt % or a majority weight percent of ethylene (based on the weight of the interpolymer), an alpha-olefin and a silane monomer. As used herein, these interpolymer comprises at least one Si—H group, as discussed above. The ethylene/silane interpolymer is formed by the copolymerization of at least the ethylene, the alpha-olefin and the silane monomer.

The term “ethylene/alpha-olefin/silane terpolymer,” as used herein, refers to a random terpolymer that comprises, in polymerized form, 50 wt % or a majority weight percent of ethylene (based on the weight of the terpolymer), an alpha-olefin and a silane monomer as the only three monomer types. As used herein, the terpolymer comprises at least one Si—H group, as discussed above. The ethylene/silane terpolymer is formed by the copolymerization of the ethylene, the alpha-olefin and the silane monomer.

In the present application, when referring to a preceding list of elements (e.g., ingredients), the phrases “mixture thereof,” “combination thereof,” and the like mean any two or more, including all, of the listed elements. The term “or” used in a listing of members, unless stated otherwise, refers to the listed members individually as well as in any combination, and supports additional embodiments reciting any one of the individual members (e.g., in an embodiment reciting the phrase “10 percent or more,” the “or” supports another embodiment reciting “10 percent” and still another embodiment reciting “more than 10 percent.”). The term “plurality” means two or more, where each plurality is independently selected unless indicated otherwise. The terms “first,” “second,” et cetera serve as a convenient means of distinguishing between two or more elements or limitations (e.g., a first chair and a second chair) and do not imply quantity or order unless specifically so indicated. The symbols “<” and “>” respectively mean less than or equal to and greater than or equal to. The symbols “<” and “>” respectively mean less than and greater than.

As used herein the term “alkyl groups” mean a saturated straight or branched (where possible) hydrocarbon radical of the number of carbons provided that is unsubstituted or substituted by at least one R^{s}. So, for example, alkyl groups of 1 to 4 carbon atoms can include, but are not limited to, methyl; ethyl; 1-propyl; 2-propyl; 1-butyl; 2-butyl; 2-methylpropyl; and 1,1-dimethylethyl. Examples of substituted alkyl groups of 1 to 4 carbon atoms can include, but are not limited to, those provided herein where at least one hydrogen is substituted by one R^{s}, where each R^{s} is independently a halogen atom.

As used herein, herein the term “aryl groups” mean an unsubstituted or substituted (by at least one R$) mono- or bi-aromatic hydrocarbon radical of from 6 to 10 ring carbon atoms (e.g., aryl groups of 6 to 10 carbon atoms), and the mono- or bi-radical comprises 1 or 2 rings, respectively, where the 1 ring and 2 ring are aromatic and the 2 ring can be fused or non-fused to the 1 ring. Examples of substituted aryl groups of 6 to 10 carbon atoms can include, but are not limited to, those provided herein where at least one hydrogen is substituted by one R^{s}, where each R^{s} is independently a halogen atom.

As used herein, the term “silyl hydride-functionalized polyolefin” is used to describe either a polyolefin copolymer formed using an alpha-olefin monomer and an alpha-silyl monomer or b) a polyolefin terpolymer formed using an alpha-olefin monomer, an olefin comonomer and an alpha-silyl monomer. As used herein, the term “alpha-olefin monomer” can include ethylene (CH₂═CH₂), propylene (CH₂═CH₂—CH₃) or a combination thereof. As used herein, the term “olefin comonomer” can include vinyl acetate, 1-butene, 2-butene, iso-butene, styrene, acrylic acid, methyl acrylate, vinyl chloride, 1-hexene, 1-octene, and dienes such as butadiene and isoprene. Other olefin comonomers are also possible. In addition, the silyl hydride-functionalized polyolefin of the present disclosure can be formed, as discussed herein, as a block copolymer/terpolymer or as a random copolymer/terpolymer.

As discussed herein, the method of the present disclosure is for the preparing of a silanol-functional polyolefin that includes combining, under thermal conditions to effect synthesis of a silanol moiety, starting materials comprising:
A) a silyl hydride-functionalized polyolefin,
optionally B) a solvent,
C) a peroxy acid,
optionally D) a neutralizing agent.
   Combining the above starting materials, as discussed herein, forms a reaction mixture that under the thermal conditions discussed herein produces the silanol-functional polyolefin having the silanol moiety according to the present disclosure. Each of the above listed starting materials A), C) and optionally B) and/or D) are discussed herein, along with the thermal conditions to effect synthesis of the silanol moiety. For the present disclosure, preparing the silanol-functional polyolefin according to the present disclosure occurs without the use or in the presence of a catalyst.

### Silyl Hydride-Functionalized Polyolefin

The silyl hydride-functionalized polyolefin of the present disclosure can be prepared according to any one of the following: U.S. Pat. Pub. 2023/0272206, U.S. Pat. No. 6,624,254; WO 2012/027448; WO 2012/027448 and WO 1995/000526, each of which is incorporated herein by reference in their entirety.

For the present disclosure the silyl hydride-functionalized polyolefin includes at least one of a silyl hydride moiety of Formula I:

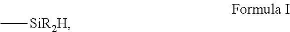

where each R is independently selected from the group consisting of alkyl groups of 1 to 4 carbon atoms and aryl groups of 6 to 10 carbon atoms, both as defined herein. For the present disclosure, preferably each R is a methyl group. For the present disclosure, the silyl hydride-functionalized polyolefin includes 0.10 weight percent (wt. %) to 10 wt. % of the silyl hydride moiety of Formula I based on the total weight of the silyl hydride-functionalized polyolefin. All individual values and subranges from 0.10 wt. % to 10 wt. % are included; for example, the wt. % of the silyl hydride moiety of Formula I can have a lower limit of 0.10, 0.20, 0.40 or 1.0 wt. % to an upper limit of 10, 8, 6 or 4 wt. % based on the total weight of the silyl hydride-functionalized polyolefin.

For the present disclosure, the silyl hydride-functionalized polyolefin is selected from the group consisting of a silyl hydride-functionalized polyethylene and a silyl hydride-functionalized polypropylene. In addition, the silyl hydride-functionalized polyolefin can be a branched silyl hydride-functionalized polyolefin. For example, silyl hydride-functionalized polyolefin can be a branched silyl hydride-functionalized polyethylene or a branched silyl hydride-functionalized polypropylene.

For the present disclosure, the silyl hydride moiety of Formula I is derived from a silane monomer selected from Formula II:

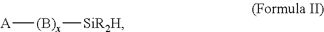

where A is an alkenyl group of 2 to 12 carbon atoms; B is a hydrocarbyl group of 1 to 10 carbon atoms; R is as defined above, H is hydrogen, and x is 0 to 10. For the present disclosure, x can also be from 0 to 8, or from 0 to 6, or from 0 to 4, or from 0 to 2, or 0 or 1, or 0. For the present disclosure, A can be a C2-C12 alkenyl group, and further a C2-C8 alkenyl group, further a C2-C6 alkenyl group, further a C2-C4 alkenyl group. In one embodiment, or a combination of two or more embodiments, each described herein, Formula II can be selected from the following compounds a) through h) below:

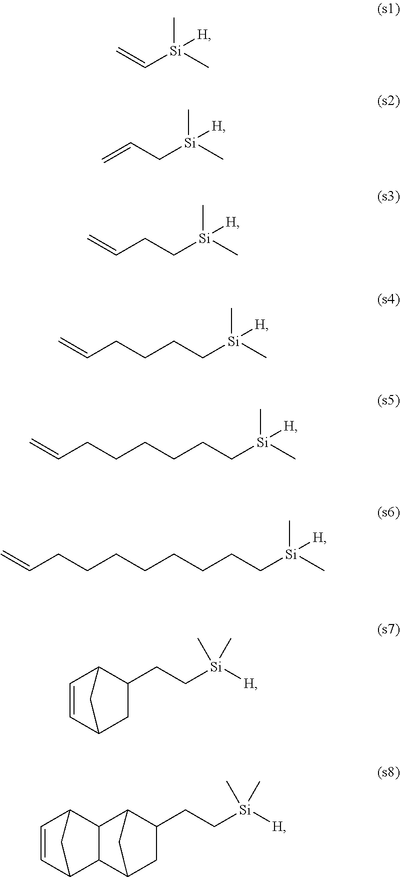

Some examples of the silane monomer of Formula II include hexenyl silane, allyl silane, vinyl silane, octenyl silane, hexenyl dimethyl silane, octenyl dimethyl silane, vinyl dimethyl silane, vinyl diethyl silane, vinyl di (n-butyl) silane, vinyl methyl octadecyl silane, allyl dimethyl silane, allyl diethyl silane, allyl di (n-butyl) silane, allyl methyl octadecyl silane and bishexenyl silane. Mixtures of the foregoing alkenylsilanes may also be used. More specific examples of silane monomers of Formula II include the following: 5-hexenyl-dimethylsilane (HDMS), 7-octenyldimethylsilane (ODMS), allyldimethylsilane (ADMS), 3-butenyldimethylsilane, 1-(but-3-en-1-yl)-1,1,3,3-tetramethyldisiloxane (BuMMH), and 1-(hex-5-en-1-yl)-1,1,3,3-tetramethyldisiloxane (HexMMH). Mixtures of the foregoing alkenylsilanes may also be used.

Additional monomers used in the forming the silyl hydride-functionalized polyolefin of the present disclosure can include addition polymerizable monomers that include olefins or mixtures of olefins and diolefins. Most preferred olefins are the C₂₋₂₀ α-olefins and mixtures thereof, most preferably, ethylene, propylene, and mixtures of ethylene with propylene, 1-butene, 1-hexene or 1-octene.

The process for forming the silyl hydride-functionalized polyolefin of the present disclosure using the monomer(s) of Formula II may be conducted under slurry, solution, bulk, gas phase or suspension polymerization conditions or other suitable reaction conditions. The polymerization can be conducted at temperatures of from 0° C. to 180° C., preferably from 25° C. to 170° C. for a time sufficient to produce the desired polymer. Typical reaction times are from one minute to 100 hours, preferably from 1 to 10 hours. The optimum reaction time or reactor residence time will vary depending upon the temperature, solvent and other reaction conditions employed. The polymerization can be conducted at subatmospheric pressure as well as super-atmospheric pressure, suitably at a pressure within the range of 1 to 800 psig (6.9 kPa-5,515 kPa).

Suitable catalysts and cocatalysts for use herein preferably include those provided in WO 2012/027448; WO 2012/027448 and WO 1995/000526. Examples of such catalyst and cocatalysts are provided in the Examples section herein. For example, the catalyst can include the following structure:

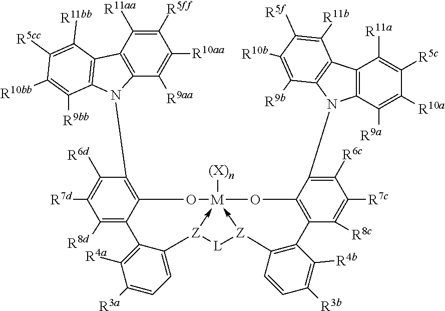

where M is a metal of any one of Groups 3 to 6 of the Periodic Table of the Elements, the metal M being in a formal oxidation state of +2, +3, +4, +5, or +6; n is an integer of from 0 to 5, where when n is 0, X is absent; each X independently is a monodentate ligand that is neutral, monoanionic, or dianionic; or two X are taken together to form a bidentate ligand that is neutral, monoanionic, or dianionic; X and n are chosen in such a way that the metal-ligand complex of formula (I) is, overall, neutral; each Z independently is O, S, N (Ci-C4g) hydrocarbyl, or P (Cⱼ-C4Q) hydrocarbyl; L is (Ci-C4Q) hydrocarbylene or (Ci-C4Q) heterohydrocarbylene, where the
(Ci-C4Q) hydrocarbylene has a portion that comprises a 1-carbon atom to 18-carbon atom linker backbone linking the Z atoms in formula (I) and the (Ci-C4Q) heterohydrocarbylene has a portion that comprises a 1-atom to 12-atom linker backbone linking the Z atoms in formula (I), where each of the from 1 to 18 atoms of the 1-atom to 18-atom linker backbone of the (Cj-C4Q) heterohydrocarbylene independently is a carbon atom or a heteroatom,
where each heteroatom independently is O, S, S(O), S(0)2, Si(R^{c})2, P(R^{p}), or N(R^{N}), where independently each R^{c} is unsubstituted (Cj-Cj g) hydrocarbyl, each R^{p} is unsubstituted (Cj-Cj g) hydrocarbyl; and each R^{N} is unsubstituted (Cj-Cj g) hydrocarbyl or absent; each of R\hat{ }^{a}, R\hat{ }^{a}, R\hat{ }b and R\hat{ }b independently is a hydrogen atom (CᵣC₄₀) hydrocarbyl; (CᵣC₄₀) heterohydrocarbyl; -; Si(R^{c}) ₃; 0(R^{C}); S(R^{C}); N(R^{N})2; P(R^{p})2 or halogen atom; at least one of R^{6c}, R^{7c}, and R^{8c} and at least one of R^{6d}, R^{7d}, and R^{8d} independently is (C₂-C4o) hydrocarbyl; Si(R^{c})3 and each of the others of R\hat{ }^{c}, R^{7c}, R^{8c}, R^{6d}, R^{7d}, and R^{8d} independently is a hydrogen atom; (Cj-C4Q) hydrocarbyl; (Cᵣ/C₄o) heterohydrocarbyl; -; Si(R^{c})₃; 0(R^{C}); S(R^{C}); N(R^{N})₂; P(R^{P})2 or halogen atom optionally two or more R groups (from R\hat{ }^{a} to R^{8d}) can combine together into ring structures, with such ring structures having from 3 to 50 atoms in the ring not counting hydrogen atoms. The molar ratio of polymerizable monomer(s) to catalyst may range from 100:1 to 1×10¹⁰:1, preferably from 1000:1 to 1×10⁶:1.

Another example of a suitable catalyst can include:

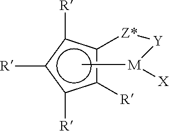

where R′ each occurrence is independently selected from hydrogen, hydrocarbyl, silyl, germyl, cyano, halo and combinations thereof, said R′ having up to 20 non-hydrogen atoms, and optionally two R′ groups (when R′ is not hydrogen, halo or cyano) together form a divalent derivative thereof connected to adjacent positions to the cyclopentadienyl ring to form a fused ring structure, X is a neutral q⁴-bonded diene group having up to 30 non-hydrogen atoms, which forms a π-complex with M, Y is -0-, —S—, —NR*—, —PR*—, M is titanium or zirconium in the +2 formal oxidation state, Z* is SiR*₂, CR*2. SiR*₂SIR*2, CR*2CR^{j}2 CR*=CR*, CR*₂SiR*₂ or GeR*₂, where R′ each occurrence is independently hydrogen, or a member selected from hydrocarbyl, silyl, halogenated alkyl, halogenated aryl, and combinations thereof, said R* having up to 10 non-hydrogen atoms, and optionally, two R′ groups from, or an R′ group from Z′ and an R* group from Y (when R* is not hydrogen) form a ring system. The molar ratio of polymerizable monomer(s) to catalyst may range from 100:1 to 1×10¹⁰:1, preferably from 1000:1 to 1×10⁶:1.

A support may be optionally present in the catalyst formulation especially in a gas phase or slurry polymerization. Suitable supports include any inert, particulate material, but most suitably is a metal oxide, preferably alumina, silica, or an aluminosilicate material. Suitable particle sizes are from 1 to 1000 μm, preferably from 10 to 100 μm. Most desired supports are calcined silica, which may be treated to reduce surface hydroxyl groups by reaction with a silane, or similar reactive compound. Any suitable means for including such support in the catalyst formulation may be used, such as by dispersing the components in a liquid and contacting the same with the support and thereafter drying, by spraying, or coating the support with such liquid and thereafter removing the liquid, or by coprecipitating the cocatalyst and a support material from a liquid medium.

The polymerization may be conducted in the presence of an inert diluent or solvent or in the absence thereof, that is, in the presence of excess monomer. Examples of suitable diluents or solvents include C₆₋₂₀ aliphatic, cycloaliphatic, aromatic and halogenated aliphatic or aromatic hydrocarbons, as well as mixtures thereof. Preferred diluents comprise the C₆₋₁₀ alkanes, toluene and mixtures thereof. A particularly desirable diluent for the polymerization is iso-octane, iso-nonane or blends thereof such as Isopar-ET, available from Exxon Chemical Company. Suitable amounts of solvent are employed to provide a monomer concentration from 5 percent to 100 percent by weight. The polymerization may be conducted in the presence of hydrogen.

The polymerization is desirably carried out as a continuous polymerization, in which catalyst components, monomer(s), and optionally solvent are continuously supplied to the reaction zone and polymer product continuously removed therefrom. Within the scope of the terms “continuous” and “continuously” as used in this context are those processes in which there are intermittent additions of reactants and removal of products at small regular intervals, so that, over time, the overall process is continuous.

For the present disclosure, the silyl hydride-functionalized polyolefin can have a number average molecular weight (Mn) from ≥10,000 g/mol, or ≥12,000 g/mol, or ≥14,000 g/mol, or ≥16,000 g/mol, or ≥18,000 g/mol, or ≥20,000 g/mol, or ≥22,000 g/mol, or ≥24,000 g/mol≥26,000 g/mol, or ≥28,000 g/mol, or ≥30,000 g/mol, or ≥32,000 g/mol, to ≤100,000 g/mol, or 95,000 g/mol, or 90,000 g/mol, or ≤85,000 g/mol, or ≤80,000 g/mol, or 75,000 g/mol, or ≤70,000 g/mol, or ≤68,000 g/mol, or ≤66,000 g/mol, or ≤64,000 g/mol, or ≤62,000 g/mol, or ≤60,000 g/mol. For the present disclosure, the silyl hydride-functionalized polyolefin can have a weight average molecular weight (Mw) from ≥20,000 g/mol, or ≥25,000 g/mol, or ≥30,000 g/mol, or ≥35,000 g/mol, or ≥40,000 g/mol, or ≥45,000 g/mol, or ≥50,000 g/mol, or ≥52,000 g/mol, or ≥54,000 g/mol, or ≥56,000 g/mol, or ≥58,000 g/mol, or ≥60,000 g/mol, or ≥62,000 g/mol to ≤300,000 g/mol, or ≤250,000 g/mol, or ≤200,000 g/mol, or ≤190,000 g/mol, or ≤180,000 g/mol, or ≤170,000 g/mol, or ≤160,000 g/mol, or ≤150,000 g/mol, or ≤148,000 g/mol, or ≤146,000 g/mol, or ≤144,000 g/mol, or ≤142,000 g/mol, or ≤140,000 g/mol, or ≤138,000 g/mol. For the present disclosure, the silyl hydride-functionalized polyolefin can also have a molecular weight distribution (MWD=Mw/Mn) from ≥1.5, or ≥1.6, or ≥1.7, or ≥1.8, or ≥1.9 to $5.0, or ≤4.5, or ≤4.0, or ≤3.5, or ≤3.0, or ≤2.9, or≤2.8, or ≤2.7, or 2.6, or 2.5, or ≤2.4, or ≤2.3. Measurement techniques for Mw, and Mn are as described in the Examples section herein.

For the present disclosure, the silyl hydride-functionalized polyolefin can have a density from ≥0.855 g/cc, or ≥0.856 g/cc, or ≥0.857 g/cc, or ≥0.858 g/cc, or ≥0.859 g/cc, or ≥0.860 g/cc, or ≥0.861 g/cc, or ≥0.862 g/cc, or ≥0.863 g/cc, or ≥0.864 g/cc, or ≥0.865 g/cc, or ≥0.866 g/cc, or ≥0.867 g/cc (1 cc=1 cm³) to ≤0.950 g/cc, or ≤0.920 g/cc, or ≤0.900 g/cc, or ≤0.890 g/cc, or ≤0.888 g/cc, or ≤0.886 g/cc, or ≤0.884 g/cc, or ≤0.882 g/cc, or ≤0.880 g/cc, or ≤0.878 g/cc, or ≤0.876 g/cc, or ≤0.874 g/cc. The measurement technique for the density is as described in the Examples section herein.

For the present disclosure, the silyl hydride-functionalized polyolefin can have a melt index (12) from ≥0.5 dg/min, or ≥1.0 dg/min, or ≥2.0 dg/min, or ≥5.0 dg/min, or ≥10 dg/min to ≤100 dg/min, or ≤50 dg/min, or ≤30 dg/min, or ≤20 dg/min, or ≤15 dg/min. The measurement technique for the melt index (12) is as described in the Examples section herein.

### Thermal Conditions to Effect Synthesis of a Silanol Moiety

For the present disclosure, the method of preparing the silanol-functional polyolefin include combining A), C) and optionally B) and/or D), to form the reaction mixture that under the thermal conditions produces the silanol-functional polyolefin having the silanol moiety as discussed herein. For the embodiments, the thermal conditions include heating the reaction mixture, as discussed herein, to a temperature near or above the melting temperature (Tm) of the silyl hydride-functionalized polyolefin. For example, forming the reaction mixture by combining A), C) and optionally B) and/or D) while also providing the thermal conditions to produce the silanol-functional polyolefin having the silanol moiety can be achieved through melt-blending using a number of different devices. For the various embodiments, the number of different devices are designed to heat, mix, and process the reaction mixture in a molten state to produce the silanol-functional polyolefin having the silanol moiety as discussed herein. Examples of such devices include single-screw extruders, double-screw extruders, internal batch mixers (e.g., Banbury mixers and intermix mixers) and kneaders or sigma blade mixers. For each of the devices, heat can be provided in addition to the friction of mixing by the container or housing in which the reaction mixture is being processed. So, for example, the single or double screw extruder can have a heated barrel to add heat to the reaction mixture as needed.

As disclosed herein, the thermal conditions to effect synthesis of the silanol moiety include combining (e.g., melt-blending) the reaction mixture, as discussed herein, at a temperature of 100° C. to 180° C. for a duration from 30 seconds to 60 minutes. All individual values and subranges from 100 to 180° C. are included; for example, the thermal condition can have a lower limit of 100, 110, 120 or 130° C. to an upper limit of 180, 170, 160, or 150° C. For the duration (e.g., reaction time), all individual values and subranges from 30 seconds to 60 minutes are included; for example, the duration can have a lower limit of 30, 60, 90, 120 or 150 seconds to an upper limit of 60, 45, 30, 20, 10 or 5 minutes. Any combination of the above individual values for the temperature and the duration are also possible.

### B) Solvent

As disclosed herein, the method of the present disclosure can also optionally use a solvent, B) to aid mixing of starting materials A) and C) of the reaction mixture. For example, A) the silyl hydride-functionalized polyolefin may be dissolved in B) the solvent before combining A) the silyl hydride-functionalized polyolefin and C) the peroxy acid. Solvents that can be used herein are those that help fluidize starting materials A) and C), but essentially do not react therewith. The solvent may be selected based on solubility of starting materials A) and C) and volatility of the solvent. The solubility refers to the solvent being sufficient to dissolve and/or disperse a starting material (e.g., A)). Volatility refers to vapor pressure of the solvent. For example, if the solvent is not volatile enough (too low vapor pressure) the solvent may be difficult to remove later in the process.

When present, the solvent is a non-polar solvent that can, among other things, act to dissolve the silyl hydride-functionalized polyolefin along with helping to control exotherms of the present method. Examples of suitable non-polar solvents include C₆-C₂₀ aliphatic, cycloaliphatic, aromatic and halogenated aliphatic or aromatic hydrocarbons, as well as mixtures thereof. Preferred non-polar solvents include C₆-C₁₀ alkanes, toluene and mixtures thereof. A particularly desirable non-polar solvent for the synthesis of the silanol moiety is toluene, iso-octane, iso-nonane or blends thereof such as Isopar-E™, available from Exxon Chemical Company.

When B) solvent is present, the thermal conditions to effect synthesis of the silanol moiety includes dissolving the silyl hydride-functionalized polyolefin in B) the solvent of the reaction mixture. The amount of solvent will depend on various factors including the type of solvent selected and the amount and type of other starting materials selected for use in the method. For the present disclosure, a suitable solvent to silyl hydride-functionalized polyolefin ratio for dissolving silyl hydride-functionalized polyolefin in B) the solvent can be in a range of 15:1 to 1:1 (milliliter solvent: grams silyl hydride-functionalized polyolefin). As disclosed herein, the thermal conditions to effect synthesis of the silanol moiety when B) the solvent is present in the reaction mixture includes heating the reaction mixture at a temperature of 60° C. to 120° C. for a duration from one minute to 60 minutes. All individual values and subranges from 60 to 120° C. are included; for example, the thermal condition can have a lower limit of 60, 65, 70 or 75° C. to an upper limit of 120, 115, 110, 105 or 100° C. For the duration (e.g., reaction time), all individual values and subranges from 1 to 60 minutes are included; for example, the duration can have a lower limit of 1, 2, 3, 4 or 5 minutes to an upper limit of 60, 45, 30, 20 or 10 minutes. Any combination of the above individual values for the temperature and the duration are also possible.

In one embodiment, the method of the present disclosure as discussed herein occurs in the absence of the solvent, B). So, for example, melt-blending the reaction mixture at the thermal conditions to effect synthesis of the silanol moiety as discussed herein can occur (e.g., occurs) in the absence of a solvent.

### C) Peroxy Acid

As disclosed herein, the method of preparing the silanol-functionalized polyolefin includes the use of a peroxy acid. As used herein, a peroxy acid is a class of organic compounds that include a peroxide group (O—O) bonded to a carboxylic acid group (—COOH), which makes them an oxidizing agent. Without wishing to be bound by theory, it is thought that the peroxy acid acts as an oxidant, thereby forming a silanol (Si—OH) moiety from an Si—H moiety of starting material A) of the method described herein. For the present disclosure, the peroxy acid is selected from the group consisting of peracetic acid, meta-chloroperbenzoic acid, perbenzoic acid and combinations thereof. In particular, the use of peracetic acid for use as an oxidant for —SiH to —SiOH is surprising as peracetic acid is typically considered a milder oxidant and so are expected to give somewhat worse reaction efficiencies. Another surprising result of the present disclosure is that for the peroxy acids there is a small molecular weight change (crosslinking) at the high temperatures required for the reaction. The results of the present disclosure are therefore surprising in that peracetic acid would be effective for this transformation.

For the present disclosure, the amount of peroxy acid used in the method of preparing the silanol-functionalized polyolefin includes from 1 to 3 molar equivalents of peroxy acid based on silicon bonded hydrogen content of A) the silyl hydride-functionalized polyolefin. Other ranges for the amount of peroxy acid used in the method of preparing the silanol-functionalized polyolefin are also possible. For example, the amount of peroxy acid used in the method of preparing the silanol-functionalized polyolefin can include not only 1 to 3, but also 1.2 to 2; 1.2 to 3; or 2 to 3 molar equivalents of peroxy acid based on silicon bonded hydrogen content of A) the silyl hydride-functionalized polyolefin. As used herein, the molar equivalents of peroxy acid based on the silicon bonded hydrogen content of the silyl hydride-functionalized polyolefin is the molar amount of the peroxy acid used in the present method (e.g., 1 to 3 moles of peroxy acid) to react with one mole of the —SiH moieties present in the silyl hydride-functionalized polyolefin of the present disclosure.

For the present disclosure, the peroxy acid can be used neat or as an aqueous solution. When used in an aqueous solution, the peroxy acid is present in an amount of 5 to 50 wt. % based on the total weight of the aqueous solution. For the present disclosure, the discovery that aqueous peracetic acid is a stoichiometric oxidant for the synthesis of —SiOH from —SiH is surprising. For example, the use of aqueous peracetic acid as described herein allows for high conversions of —SiH to —SiOH in short reaction times (<20 min) and at high temperatures required for melt or solution functionalization, where such reactions can occur either in the presence of a non-polar solvent, such as toluene or others as provided herein, in a polymer melt state. In addition, the peroxy acid provided herein are commercially available. In addition, the peroxy acid of the present disclosure are degradable to relatively benign and volatile (e.g., can be stripped) by-products, such as hydrogen peroxide, acetic acid, and water, making the present method fairly “green.” Low/controllable molecular weight growth upon functionalization and stable molecular weight of SiOH polymer upon prolonged storage.

The aqueous solution of the peroxy acid can also include other compounds to adjust the pH of the aqueous solution, where such compounds can include acids such as acetic acid, sulfuric acid, nitric acid, phosphoric acid, perchloric acid and hydrochloric acid, among other mineral acids. For the present disclosure the pKa of the peroxy acid in aqueous solution can be in the range of 4 to 10

### D) Neutralizing Agent

As disclosed herein, the method of the present disclosure can also optionally use a neutralizing agent, D) in the reaction mixture. Without wishing to be bound by theory, it is thought that peroxy acid, as provided herein, comprises residual mineral acid (e.g., in the commercially available peracetic acid, pH is <1). The neutralizing agent may be added to prevent or minimize undesired condensation. For example, a mildly basic neutralizing agent may be added in an amount sufficient to give C) the peracetic acid a pH of 3 to 4, where condensation is relatively slow. Starting material D) the neutralizing agent may be added with the other starting materials A) and C), or starting materials comprising C) the peroxy acid may be combined with D) the neutralizing agent before combining with starting material A). Suitable neutralizing agents include sodium carbonate, sodium bicarbonate, calcium carbonate CaO₃, and potassium carbonate, all of which are commercially available, for example, from Sigma-Aldrich, Inc.

### Additives

The silanol-functional polyolefin of the present disclosure may also include one or more additives. Additives include, but are not limited to, UV stabilizer, antioxidants, fillers, scorch retardants, tackifiers, waxes, compatibilizers, adhesion promoters, plasticizers (for example, oils), blocking agents, antiblocking agents, anti-static agents, release agents, anti-cling additives, colorants, dyes, pigments, and combination thereof.

Separating the Silanol-Functional Polyolefin from the Reaction Mixture

As disclosed herein, the method of the present disclosure further comprises separating the silanol-functional polyolefin from the reaction mixture. Separation of the silanol-functional polyolefin from the reaction mixture, with or without the presence of the solvent B), can be achieved through a variety of techniques, including precipitation in a suitable polar solvents, by cooling the silanol-functional polyolefin to below its glass-transition temperature, through a salting out process (e.g., when in the presence of the solvent B), or through a spray drying process (e.g., when in the presence of the solvent B). Examples of suitable polar solvents for the separation of the silanol-functional polyolefin from the reaction mixture include polar aprotic solvents such as acetone and acetonitrile, among others known in the art. Other polar solvents, such as alcohols, are not preferred as they can lead to alkoxysilane byproducts. Once separated, the silanol-functional polyolefin can be washed one or more times with the polar aprotic solvent and then dried (e.g., at elevated temperatures, 30-50° C. under dry nitrogen).

### Examples

The Inventive Examples (IE) and Comparative Examples (CE) were derived using the following materials and methods. Table 1 provides the materials used in the IE and CE.

### General Process

Polymer substrates are provided in Table 1A, where each polymer substrate is an —SiH containing polyolefin. For each IE and CE, the respective polymer substrate was either melt blended in a twin screw extruder (Thermo Fisher Scientific Process 11 Twin Screw Extruder) to a temperature at or above the melt temperature of the polymer substrate (Tables 1A and 2A/2B) and as discussed herein or dissolved in a solvent and temperature as provided in Tables 1A and 3A/3B and discussed herein. The peracid, as provided in the below Tables, was introduced in equimolar to threefold molar excess to the moles of silane groups (—SiH).

TABLE 1A
Materials

| Substance | Role | Description | Source |
|---|---|---|---|
| Polymer 1 | Substrate | | Synthesis |
| (Poly 1) | | | Described Below |
| | | | (SiH-POE F) |
| Polymer 2 | Substrate | | Synthesis |
| (Poly 2) | | | Described Below |
| | | | (SiH-POE G) |
| Polymer 3 | Substrate | | Synthesis |
| (Poly 3) | | | Described Below |
| Polymer 4 | Substrate | | Synthesis |
| (Poly 4) | | | Described Below |
| | | | (SiH-POE D) |
| Polymer 5 | Substrate | | Synthesis |
| (Poly 5) | | | Described Below |
| | | | (SiH-POE E) |
| Toluene | Solvent | | Sigma-Aldrich |
| (Tol) | | | |
| Meta- | Oxidant | ≤77% | Sigma-Aldrich |
| Chloro- | | | |
| perbenzoic | | | |
| Acid | | | |
| (mCPBA) | | | |
| tert-butyl | Oxidant | 5.0-6.0M in decane | Sigma-Aldrich |
| hydroperoxide | | | |
| (tBHP) | | | |
| Peracetic acid | Oxidant | ~32 wt % in water with | Alfa Aesar |
| (PAA-1) | | AcOH, H₂O₂, H₂O, and | |
| | | H₂SO₄ | |
| | | PAA-1 was partially | |
| | | neutralized immediately | |
| | | prior to use to pH ~3.5 | |
| | | with 60 mg NaHCO₃ | |
| Peracetic acid | Oxidant | ~8% in AcOH, H₂O₂, | ChemCatChem |
| (PAA-2) | | and H₂O | 2015, 7, |
| | | | 1865-1870 |

AcOH - acetic acid

### Polymer Syntheses and Properties

Polymer 1-Polymer 5 (Poly 1-Poly 5, Table 1A) were each prepared in a one gallon polymerization reactor that was hydraulically full and operated at steady state conditions. Detailed synthesis information is provided below. The solvent was ISOPAR-E, supplied by the ExxonMobil Chemical Company. 5-hexenyl-dimethylsilane (HDMS) supplied by Gelest was used as a termonomer and was purified over AZ-300 alumina supplied by UOP Honeywell prior to use. HDMS was fed to the reactor as a 22 wt. % solution in ISOPAR-E. The reactor temperature was measured at or near the exit of the reactor. The Polymer was isolated and pelletized. Polymerization conditions are listed in Table 1C-1E, and catalysts are shown in Table 1B. The polymer properties of each ethylene/octene/silane polymer (SiH-POE) and ethylene/octene interpolymer (a polyolefin elastomer, “POE”) are shown in Tables 2A and 2B.

TABLE 1B
Catalysts and co-catalysts

| Catalyst (CAT) | Description |
|---|---|
| PE CAT 1 (WO2012/027448) | 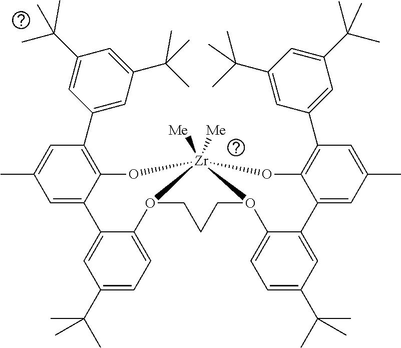 |
| PE CAT 2 (WO2012/027448) | 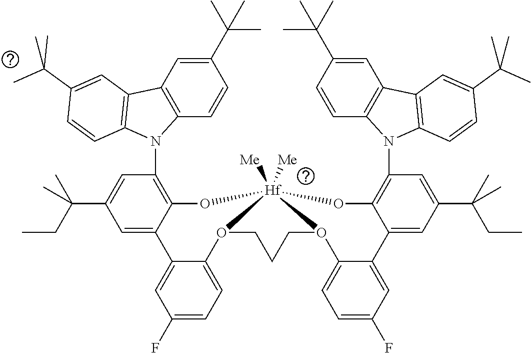 |
| PE CAT 3 (WO1995/000526) | 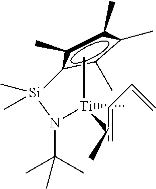 |
| Cocatalyst | A mixture of methyldi(C14-18 alkyl)ammonium salts of |
| CoCAT-1 | tetrakis(pentafluorophenyl)borate, prepared by reaction of a long |
| | chain trialkylamine (Armeen ™ M2HT, available from Akzo-Nobel, |
| | Inc.), HCl and Li[B(C6F5)4], substantially as disclosed in USP |
| | 5,919,983, Ex. 2 (no further purification performed) (Boulder |
| | Scientific) |
| CoCAT-2 | Modified methylalumoxane (MMAO) Type 3A (no further purification |
| | performed) (Akzo Nobel) |

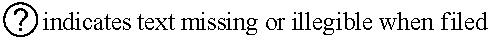

TABLE 1C
Polymerization Conditions to produce SiH-POE

| | | Reactor | | | | | | ethylene |
|---|---|---|---|---|---|---|---|---|
| | Reactor | Pressure, | Solvent, | Ethylene, | Octene, | HDMS, | Hydrogen, | conversion, |
| | Temp., | psig | lb/hr | lb/hr | lb/hr | lb/h | sccm | % |
| Poly 4 | 170 | 729 | 38 | 3.8 | 5.0 | 1.4 | 192 | 83 |
| (SiH-POE D) | | | | | | | | |
| R02 | | | | | | | | |
| Poly 5 | 168 | 726 | 36 | 3.8 | 5.0 | 2.9 | 193 | 82 |
| (SiH-POE E) | | | | | | | | |
| R03 | | | | | | | | |
| Poly 1 | 170 | 725 | 22 | 4.1 | 5.6 | 1.4 | 90 | 89 |
| (SiH-POE F) | | | | | | | | |
| R11 | | | | | | | | |
| Poly 2 | 170 | 725 | 17 | 3.6 | 4.2 | 3.1 | 89 | 89 |
| (SiH-POE G) | | | | | | | | |
| R07 | | | | | | | | |
| Poly 3 | 135 | 725 | 14 | 5.0 | 4.9 | 0.4 | 119 | 92 |
| R09 | | | | | | | | |

TABLE 1D
Catalyst Feed Flows and Efficiency

| | | | Catalyst | Overall Catalyst |
|---|---|---|---|---|
| | | Catalyst | Solution | Efficiency, (g |
| | | Solution | Metal | interpolymer/g |
| | | Flow, | Conc., | total catalyst |
| | Catalyst | lb/hr | ppm* | metal) |
| Poly 4 | PE CAT 2 | 0.33 | 3.96 | 3,911,000 |
| (SiH-POE D) | | | | |
| R02 | | | | |
| Poly 5 | PE CAT 2 | 0.57 | 3.96 | 2,385,000 |
| (SiH-POE E) | | | | |
| R03 | | | | |
| Poly 1 | PE CAT 1 | 0.48 | 14.68 | 914,000 |
| (SiH-POE F) | | | | |
| R11 | | | | |
| Poly 2 | PE CAT 1 | 0.17 | 14.68 | 1,798,000 |
| (SiH-POE G) | | | | |
| R07 | | | | |
| Poly 3 | PE CAT 3 | 0.2 | 7.72 | 5,699,000 |
| R09 | | | | |

*The “ppm” amount based on the weight of the respective catalyst feed solution.

TABLE 1E
Cocatalyst Feed Flows

| | CoCAT 1 | CoCAT 1 | CoCAT 2 | CoCAT 2 |
|---|---|---|---|---|
| | Solution | Solution | Solution | Solution |
| | Flow, | Conc., | Flow, | Conc., |
| | lb/hr | ppm* | lb/hr | ppm Al** |
| Poly 4 | 0.34 | 31.25 | 0.30 | 32.2 |
| (SiH-POE D) | | | | |
| R02 | | | | |
| Poly 5 | 0.58 | 31.25 | 0.53 | 32.2 |
| (SiH-POE E) | | | | |
| R03 | | | | |
| Poly 1 | 0 | 0 | 0.25 | 317.9 |
| (SiH-POE F) | | | | |
| R11 | | | | |
| Poly 2 | 0.29 | 154.8 | 0.29 | 14.2 |
| (SiH-POE G) | | | | |
| R07 | | | | |
| Poly 3 | 0.30 | 154.8 | 0.3 | 14.16 |
| R09 | | | | |
| POE D | 0.33 | 31.25 | 0.31 | 32.2 |
| POE E | 0 | 0 | 0.26 | 317.9 |
| POE F | 0.29 | 154.8 | 0.30 | 14.2 |

*The “ppm” amount based on the weight of the co-catalyst feed solution.
**The “ppm” amount of Al based on the weight of the co-catalyst feed solution.

TABLE 2A
Polymer Properties

| Resin Description | | | | | Silane Information | | |
|---|---|---|---|---|---|---|---|
| | Density | MI | Octene | Tₘ | Silane | Silane | Silane |
| Resin | (g/cc) | (dg/min) | (mol %) | (C. °) | Type | mol %* | wt % ** |
| Poly 4 | 0.873 | 0.8 | 11.0 | 64.5 | HDMS | 0.4 | 1.5 |
| (SiH-POE D) | | | | | | | |
| R02 | | | | | | | |
| Poly 5 | 0.87 | 0.8 | 11.0 | 61.9 | HDMS | 0.9 | 3.4 |
| (SiH-POE E) | | | | | | | |
| R03 | | | | | | | |
| Poly 1 | 0.868 | 25.8 | 11.9 | 73.5 | HMDS | 0.4 | 1.6 |
| (SiH-POE F) | | | | | | | |
| R11 | | | | | | | |
| Poly 2 | 0.879 | 15.7 | 8.6 | 75.4 | HMDS | 1.0 | 4.0 |
| (SiH-POE G) | | | | | | | |
| R07 | | | | | | | |
| Poly 3 | 0.872 | — | 11.5 | 72.4 | HDMS | 0.6 | 2.3 |
| R09 | | | | | | | |
| SiH-POE H | 0.876 | 20.0 | 9.1 | 74.1 | HDMS | 0.8 | 3.0 |
| R06 | | | | | | | |
| POE A | — | — | 13.5 | 42 | — | — | — |
| POE B | 0.858 | 9.9 | 16.4 | 43 | — | — | — |
| POE C | — | — | 13.6 | 45 | — | — | — |
| POE D | 0.87 | 1.2 | 12.0 | 58.3 | — | — | — |
| POE E | 0.864 | 27.7 | 13.8 | 70.0 | — | — | — |
| POE F | 0.878 | 22.0 | 10.3 | 74.2 | — | — | — |
| POE 8407^{A} | 0.87 | 30 | — | 66 | — | — | — |
| POE 38669^{B} | 0.873 | 14 | — | 73 | — | — | — |
| POE 8200^{C} | 0.87 | 5 | — | 63 | — | — | — |
| EVA^{D} | 0.948 | 25 | — | — | — | — | — |

*Mol % silane based on total moles of monomers in polymer
**Wt % silanc calculated from the mol%, and based on the weight of the interpolymer.
F: HDMS = 5-Hexenyldimethylsilane.

TABLE 2B
Polymer Properties (Conventional GPC)

| Resin | Mn (kg/mol) | Mw (kg/mol) | Mw/Mn |
|---|---|---|---|
| Poly 4 | 49 | 108 | 2.2 |
| (SiH-POE D) | | | |
| R02 | | | |
| Poly 5 | 45 | 100 | 2.2 |
| (SiH-POE E) | | | |
| R03 | | | |
| Poly 1 | 24 | 50 | 2.1 |
| (SiH-POE F) | | | |
| R11 | | | |
| Poly 2 | 25 | 53 | 2.1 |
| (SiH-POE G) | | | |
| R07 | | | |
| Poly 3 | 8.2 | 19 | 2.3 |
| R09 | | | |

*Made with PE CAT 3 Each an ethylene/octene copolymer, prepared in similar manner, except the lack of silane, to the ethylene/octene/silane interpolymers, as discussed above.
**Made with PE CAT 4 - ethylene/octene copolymer, prepared in similar manner, except the lack of silane, to the ethylene/octene/silane interpolymers, as discussed above.

### Test Methods for Poly 1-Poly 5

### Gel Permeation Chromatography

The chromatographic system consisted of a PolymerChar GPC-IR (Valencia, Spain) high temperature GPC chromatograph, equipped with an internal IR5 infra-red detector (IR5). The autosampler oven compartment was set at 160° C., and the column compartment was set at 150° C. The columns were four AGILENT “Mixed A” 30 cm, 20-micron linear mixed-bed columns. The chromatographic solvent was 1,2,4-trichloro-benzene, which contained 200 ppm of butylated hydroxytoluene (BHT). The solvent source was nitrogen sparged. The injection volume used was 200 microliters, and the flow rate was 1.0 milliliters/minute.

Calibration of the GPC column set was performed with 21 narrow molecular weight distribution polystyrene standards, with molecular weights ranging from 580 to 8,400,000, and which were arranged in six “cocktail” mixtures, with at least a decade of separation between individual molecular weights. The standards were purchased from Agilent Technologies. The polystyrene standards were prepared at “0.025 grams in 50 milliliters” of solvent, for molecular weights equal to, or greater than, 1,000,000, and at “0.05 grams in 50 milliliters” of solvent, for molecular weights less than 1,000,000. The polystyrene standards were dissolved at 80° C., with gentle agitation, for 30 minutes. The polystyrene standard peak molecular weights were converted to polyethylene molecular weights using Equation 1 (as described in Williams and Ward, J. Polym. Sci., Polym. Let., 6, 621 (1968)):

$${M}_{polyethylene} = A \times {( {M}_{polystyrene} )}^{B} , \qquad ( EQ1 )$$

where M is the molecular weight, A has a value of 0.4315 and B is equal to 1.0.

A fifth order polynomial was used to fit the respective polyethylene-equivalent calibration points. A small adjustment to A (from approximately 0.375 to 0.445) was made to correct for column resolution and band-broadening effects, such that linear homopolymer polyethylene standard is obtained at 120,000 Mw. The total plate count of the GPC column set was performed with decane (prepared at “0.04 g in 50 milliliters” of TCB and dissolved for 20 minutes with gentle agitation). The plate count (Equation 2) and symmetry (Equation 3) were measured on a 200 microliter injection according to the following equations:

$$Plate Count = 5.54 * {( \frac{( R {V}_{Peak Max}}{Peak Width at \frac{1}{2} height} )}^{2} \qquad ( EQ2 )$$

where RV is the retention volume in milliliters, the peak width is in milliliters, the peak max is the maximum height of the peak, and ½ height is ½ height of the peak maximum; and

$$Symmetry = \frac{( Rear Peak {RV}_{one tenth height} - R {V}_{Peak max} )}{( R {V}_{Peak max} - Front Peak {RV}_{one tenth height} )} \qquad ( EQ3 )$$

where RV is the retention volume in milliliters, and the peak width is in milliliters. Peak max is the maximum position of the peak, one tenth height is 1/10 height of the peak maximum, and where rear peak refers to the peak tail at later retention volumes than the peak max, and where front peak refers to the peak front at earlier retention volumes than the peak max. The plate count for the chromatographic system should be greater than 18,000, and symmetry should be between 0.98 and 1.22.

Samples were prepared in a semi-automatic manner with the PolymerChar “Instrument Control” Software, where the samples were weight-targeted at 2 mg/ml, and the solvent (contained 200 ppm BHT) was added to a pre nitrogen-sparged, septa-capped vial, via the PolymerChar high temperature autosampler. The samples were dissolved for two hours at 160° C. under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1. Equations 4-6 are as follows:

$${Mn}_{( GPC )} = \frac{{\sum }^{i} {IR}_{i}}{{\sum }^{i} ( {IR}_{i} / {M}_{{polyethylene}_{i}} )} , \qquad ( EQ 4 )$$

$${Mw}_{( GPC )} = \frac{{\sum }^{i} ( {IR}_{i} * {M}_{{polyethylene}_{i}} )}{{\sum }^{i} {IR}_{i}} , and \qquad ( EQ 5 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} . \qquad ( EQ 6 )$$

In order to monitor the deviations over time, a flowrate marker (decane) was introduced into each sample, via a micropump controlled with the PolymerChar GPC-IR system. This flowrate marker (FM) was used to linearly correct the pump flowrate (Flowrate (nominal)) for each sample, by RV alignment of the respective decane peak within the sample (RV (FM Sample)), to that of the decane peak within the narrow standards calibration (RV (FM Calibrated)). Any changes in the time of the decane marker peak were then assumed to be related to a linear-shift in flowrate (Flowrate (effective)) for the entire run. To facilitate the highest accuracy of a RV measurement of the flow marker peak, a least-squares fitting routine was used to fit the peak of the flow marker concentration chromatogram to a quadratic equation. The first derivative of the quadratic equation was then used to solve for the true peak position. After calibrating the system, based on a flow marker peak, the effective flowrate (with respect to the narrow standards calibration) was calculated as Equation 7:

$$Flowrate ( effective ) = Flowrate ( nominal ) * ( RV ( FM Calibrated ) / RV ( FM Sample ) ) . \qquad ( EQ7 )$$

Processing of the flow marker peak was done via the PolymerChar GPCOne™ Software. Acceptable flowrate correction is such that the effective flowrate should be within +/−0.7% of the nominal flowrate.

### Melt Index

The melt index I₂ for each polymer was measured in accordance with ASTM D-1238, condition 190° C./2.16 kg (melt index I₁₀ at 190° C./10.0 kg). The I₁₀/I₂ was calculated from the ratio of I₁₀ to the I₂. The melt flow rate MFR of each polymer was measured in accordance with ASTM D-1238, condition 230° C./2.16 kg.

### Density

ASTM D4703 was used to make a polymer plaque for density analysis. ASTM D792, Method B, was used to measure the density of each polymer.

### NMR Characterization of Terpolymers

For ¹³C NMR experiments, samples were dissolved, in 10 mm NMR tubes, in tetrachloroethane-d₂ (with or without 0.025 M Cr(acac)₃). The concentration was approximately 300 mg/2.8 mL. Each tube was then heated in a heating block set at 110° C. The sample tube was repeatedly vortexed and heated to achieve a homogeneous flowing fluid. The ¹³C NMR spectrum was taken on a BRUKER AVANCE 600 MHz spectrometer, equipped with a 10 mm C/H DUAL cryoprobe. The following acquisition parameters were used: 60 seconds relaxation delay, 90 degree pulse of 12.0 μs, 256 scans. The spectrum was centered at 100 ppm, with a spectral width of 250 ppm. All measurements were taken without sample spinning at 110° C. The ¹³C NMR spectrum was referenced to “74.5 ppm” for the resonance peak of the solvent. For a sample with Cr, the data was taken with a “7 seconds relaxation delay” and 1024 scans.

Differential Scanning calorimetry (DSC)

Differential Scanning calorimetry (DSC) is used to measure Tₘ, T_{c}, T_{g} and crystallinity in each polymer sample. Each sample (0.5 g) was compression molded into a film, at 5000 psi, 190° C., for two minutes. About 5 to 8 mg of film sample was weighed and placed in a DSC pan. The lid was crimped on the pan to ensure a closed atmosphere. Unless otherwise stated, the sample pan was placed in a DSC cell, and then heated, at a rate of 10° C./min, to a temperature of 180° C. for PE (230° C. for PP). The sample was kept at this temperature for three minutes. Then the sample was cooled at a rate of 10° C./min to −90° C. for PE (−60° C. for PP) and kept isothermally at that temperature for three minutes. The sample was next heated at a rate of 10° C./min, until complete melting (second heat). Unless otherwise stated, melting point (Tₘ) and the glass transition temperature (T_{g}) of each polymer were determined from the second heat curve, and the crystallization temperature (T_{c}) was determined from the first cooling curve. The respective peak temperatures for the Tₘ and the T_{c} were recorded. The percent crystallinity can be calculated by dividing the heat of fusion (H_{f}), determined from the second heat curve, by a theoretical heat of fusion of 292 J/g for PE (165 J/g for PP), and multiplying this quantity by 100 (for example, % cryst.=(Hf/292 J/g)×100 (for PE)). In DSC measurements, it is common that multiple Tₘ peaks are observed, and here, the highest temperature peak as the Tₘ of the polymer is recorded.

### Experimental Procedures

### IE 1-IE 10: Oxidative Reactive Extrusion

Oxidative reactive extrusion for IE 1-IE 10 was carried out in an 11-mm diameter Thermo Fisher Scientific Process 11 Twin Screw Extruder (TSE) kept in a chemical fume hood. This is a compact parallel co-rotating TSE with a clamshell barrel. The extruder length is 44 L/D, including a 40 L/D barrel and a 4 L/D extension. The barrel has 6 multifunctional barrel ports for reagent injection or vacuum, and 8 separate heating zones along the barrel. The polymer substrate was ground to particle sizes below 2 mm before use to facilitate its feeding. IE 1-IE 10 each used Poly 1 as the substrate and mCPBA as the oxidant, where the polymer powder and mCPBA were dry blended. The polymer substrate was fed into the extruder using a MovaColor MCBALANCE single screw gravimetric feeder at a rate of 180 g/h. A residence time of 2.5 min was used. In general, the extruder was allowed to run for approximately 5 min for equilibration, and then samples of approximately 10-20 g were collected for analysis.

Purification was performed by precipitation of the functionalized polymer from hot toluene into methanol. The resulting purified functionalized polymer is characterized by proton NMR spectroscopy as discussed herein.

### IE11-IE18: Solvent Oxidation

Solvent oxidations for IE11-IE18 were performed as follows. The Polymer Substrate was dissolved in toluene (Table 4A) in a 3 neck round bottom flask with overhead stirring and a reflux condenser under a dry nitrogen atmosphere. Solution was heated to the temperature provided in Table 4A. The oxidant, as provided in Table 4A, was added and the mixture stirred vigorously for the time indicated in Table 4A. During the reaction, both NMR and ATR FT-IR analysis, as discussed herein, were performed on aliquots precipitated in methanol and dried briefly in an aluminum pan at 120° C. to provide the conversion of —SiH to Si—OH. Analysis was performed until the —SiH remained unchanged. The hot polymer solution was then precipitated at atmospheric pressure in room temperature (23° C.) acetone. The resulting precipitated polymer was blended in acetone, filtered, resuspended in acetone, filtered again, and dried at elevated temperatures (50° C.) under a nitrogen sweep.

### Tested Property Results

Tables 3A/3B and Tables 4A/4B provide the test results for IE 1-IE 18. Mn and Mw were determined as described herein.

TABLE 3A

| | Oxidant:SiH | Barrel Set | Reaction | Mn | Mw | Mw/ |
|---|---|---|---|---|---|---|
| | Molar Equiv | Temperature | Time | [kg/ | [kg/ | Mn |
| Ex | [molar equiv] | [° C.] | [min] | mol] | mol] | — |
| IE 1 | 1:1 | 100 | 2.5 min | 22 | 52 | 2.3 |
| IE 2 | 1:1 | 120 | 2.5 min | 21 | 50 | 2.4 |
| IE 3 | 1:1 | 140 | 2.5 min | 22 | 50 | 2.3 |
| IE 4 | 1:1 | 160 | 2.5 min | 22 | 52 | 2.4 |
| IE 5 | 1:1 | 180 | 2.5 min | 22 | 55 | 2.4 |
| IE 6 | 2:1 | 100 | 2.5 min | 22 | 60 | 2.7 |
| IE 7 | 2:1 | 120 | 2.5 min | 23 | 66 | 2.9 |
| IE 8 | 2:1 | 140 | 2.5 min | 23 | 60 | 2.7 |
| IE 9 | 2:1 | 160 | 2.5 min | 22 | 60 | 2.7 |
| IE 10 | 2:1 | 180 | 2.5 min | 20 | 60 | 3.0 |

TABLE 3B

| | Mass | SiH Conversion | SiOR Formation |
|---|---|---|---|
| | Recovery | (¹H NMR) | (²⁹Si NMR) |
| Ex | [%] | [%] | [%] |
| IE 1 | 99 | 90 | not observed |
| IE 2 | 99 | 98 | not observed |
| IE 3 | 101 | 99 | not observed |
| IE 4 | 99 | 99 | 8 |
| IE 5 | 103 | 99 | 15 |
| IE 6 | 99 | 97 | 17 |
| IE 7 | 98 | 97 | 13 |
| IE 8 | 95 | 98 | 11 |
| IE 9 | 99 | 98 | 19 |
| IE 10 | 97 | 98 | 21 |

TABLE 4A

| | | | | Oxidant: | | | |
|---|---|---|---|---|---|---|---|
| | | | | SiH | Solvent | | Reaction |
| | | Substrate | | [molar | volume | Temp | Time |
| Ex | Sub | mass [g] | Oxidant | equiv] | [mL] | [° C.] | [min] |
| IE 11 | Poly 2 | 16.5 | mCPBA | 1.2:1 | 200 | 85 | 10 |
| IE 12 | Poly 2 | 10.3 | PAA-1 | 2:1 | 125 | 85 | 20 |
| IE 13 | Poly 2 | 10 | PAA-2 | 3:1 | 100 | 85 | 20 |
| IE 14 | Poly 3 | 10 | PAA-2 | 3:1 | 100 | 85 | 20 |
| IE 15 | Poly 4 | 10 | PAA-2 | 3:1 | 100 | 85 | 20 |
| IE 16 | Poly 5 | 10 | PAA-2 | 3:1 | 100 | 85 | 20 |
| IE 17 | Poly 1 | 10 | PAA-2 | 3:1 | 100 | 85 | 20 |
| IE 18 | Poly 3 | 10 | PAA-2 | 3:1 | — | 85 | 45 |
| CE A | Poly 2 | 10.3 | tBHP | 1.2:1 | 125 | 85 | 60 |

TABLE 4B

| | | | | | SiH | SiH |
|---|---|---|---|---|---|---|
| | | | | Mass | Conversion | Conversion |
| | Mn | Mw | Mw/Mn | Recovery | (¹H NMR) | (ATR FT-IR) |
| Ex | [kg/mol] | [kg/mol] | — | [%] | [%] | [%] |
| IE 11 | 22 | 55 | 2.5 | 99 | >95 | >90 |
| IE 12 | 21 | 59 | 2.8 | 97 | 90 | >90 |
| IE 13 | 20 | 53 | 2.7 | 90 | 95 | ND |
| IE 14 | 7 | 19 | 2.5 | 89 | 94 | ND |
| IE 15 | 41 | 130 | 3.2 | 90 | 93 | ND |
| IE 16 | 34 | 154 | 4.5 | 92 | 90 | ND |
| IE 17 | 22 | 52 | 2.4 | 94 | 98 | ND |
| IE 18 | 7 | 19 | 2.6 | 90 | 85 | ND |
| CE A | — | — | — | — | — | not observed |

### Data Analysis

As seen above, IE 1-IE 10 show that oxidation by mCPBA in the TSE provides an extremely high conversion of —SiH to —SiOH moieties in the polymer substrates. This is achieved at stoichiometric equivalents of oxidant to —SiH of only 1:1 up to 3:1. Reaction temperatures for the conversion were also reasonable, in the range of 100° C. to 180° C., especially when the reaction takes place as atmospheric pressure.

The solvent oxidation process for IE 11-IE 18 demonstrated that mCPBA and PAA are effective oxidants in solution, whereas CE1 showed that tBHP was not an effective oxidant.

### Measurement Information for IE and CE

### GPC

The chromatographic system consisted of a PolymerChar GPC-IR (Valencia, Spain) high temperature GPC chromatograph, equipped with an internal IR5 infra-red detector (IR5). The autosampler oven compartment was set at 160° C., and the column compartment was set at 150° C. The columns were four AGILENT “Mixed A” 30 cm, 20-micron linear mixed-bed columns. The chromatographic solvent was 1,2,4-trichloro-benzene, which contained 200 ppm of butylated hydroxytoluene (BHT). The solvent source was nitrogen sparged. The injection volume used was 200 microliters, and the flow rate was 1.0 milliliters/minute.

Calibration of the GPC column set was performed with 21 narrow molecular weight distribution polystyrene standards, with molecular weights ranging from 580 to 8,400,000, and which were arranged in six “cocktail” mixtures, with at least a decade of separation between individual molecular weights. The standards were purchased from Agilent Technologies. The polystyrene standards were prepared at “0.025 grams in 50 milliliters” of solvent, for molecular weights equal to, or greater than, 1,000,000, and at “0.05 grams in 50 milliliters” of solvent, for molecular weights less than 1,000,000. The polystyrene standards were dissolved at 80 degrees Celsius, with gentle agitation, for 30 minutes. The polystyrene standard peak molecular weights were converted to polyethylene molecular weights using Equation 1 (as described in Williams and Ward, J. Polym. Sci., Polym. Let., 6, 621 (1968)):

M_{polyethylene}=A×(M_{polystyrene})^{B} (EQ1), where M is the molecular weight, A has a value of 0.4315 and B is equal to 1.0.

A fifth order polynomial was used to fit the respective polyethylene-equivalent calibration points. A small adjustment to A (from approximately 0.375 to 0.445) was made to correct for column resolution and band-broadening effects, such that linear homopolymer polyethylene standard is obtained at 120,000 Mw. The total plate count of the GPC column set was performed with decane (prepared at “0.04 g in 50 milliliters” of TCB and dissolved for 20 minutes with gentle agitation). The plate count (Equation 2) and symmetry (Equation 3) were measured on a 200 microliter injection according to the following equations:

$$Plate Count = 5.54 * {( \frac{R {V}_{Peak Max}}{Peak Width at \frac{1}{2} height} )}^{2} , \qquad ( EQ 2 )$$

where RV is the retention volume in milliliters, the peak width is in milliliters, the peak max is the maximum height of the peak, and ½ height is ½ height of the peak maximum; and

$$Symmetry = \frac{( Rear P eak {RV}_{one tenth height} - R {V}_{Peak max} )}{( R {V}_{Peak max} - Front Peak {RV}_{one tenth height )}} , \qquad ( EQ 3 )$$

where RV is the retention volume in milliliters, and the peak width is in milliliters, Peak max is the maximum position of the peak, one tenth height is 1/10 height of the peak maximum, and where rear peak refers to the peak tail at later retention volumes than the peak max, and where front peak refers to the peak front at earlier retention volumes than the peak max. The plate count for the chromatographic system should be greater than 18,000, and symmetry should be between 0.98 and 1.22.

Samples were prepared in a semi-automatic manner with the PolymerChar “Instrument Control” Software, where the samples were weight-targeted at 2 mg/ml, and the solvent (contained 200 ppm BHT) was added to a pre nitrogen-sparged, septa-capped vial, via the PolymerChar high temperature autosampler. The samples were dissolved for two hours at 160° C. under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1. Equations 4-6 are as follows:

$${Mn}_{( GPC )} = \frac{{\sum }^{i} {IR}_{i}}{{\sum }^{i} ( {IR}_{i} / {M}_{{polyethylene}_{i}} )} , \qquad ( EQ 4 )$$

$${Mw}_{( GPC )} = \frac{{\sum }^{i} ( {IR}_{i} * {M}_{{polyethylene}_{i}} )}{{\sum }^{i} {IR}_{i}} , \qquad ( EQ 5 )$$

$${Mz}_{( GPC )} = \frac{{\sum }^{i} ( I {R}_{i} * {M}_{{polyethylene}_{i}}^{2} )}{{\sum }^{i} ( {IR}_{i} * {M}_{{polyethylene}_{i}} )} . \qquad ( EQ 6 )$$

In order to monitor the deviations over time, a flowrate marker (decane) was introduced into each sample, via a micropump controlled with the PolymerChar GPC-IR system. This flowrate marker (FM) was used to linearly correct the pump flowrate (Flowrate (nominal)) for each sample, by RV alignment of the respective decane peak within the sample (RV (FM Sample)), to that of the decane peak within the narrow standards calibration (RV (FM Calibrated)). Any changes in the time of the decane marker peak were then assumed to be related to a linear-shift in flowrate (Flowrate (effective)) for the entire run. To facilitate the highest accuracy of a RV measurement of the flow marker peak, a least-squares fitting routine was used to fit the peak of the flow marker concentration chromatogram to a quadratic equation. The first derivative of the quadratic equation was then used to solve for the true peak position. After calibrating the system, based on a flow marker peak, the effective flowrate (with respect to the narrow standards calibration) was calculated as Equation 7:

$$Flowrate ( effective ) = Flowrate ( nominal ) * ( RV ( FM Calibrated ) / RV ( FM Sample ) ) . \qquad ( EQ7 )$$

Processing of the flow marker peak was done via the PolymerChar GPCOne™ Software. Acceptable flowrate correction is such that the effective flowrate should be within +/−0.7% of the nominal flowrate.

### NMR

Extruded polymers were analyzed by ¹H and ²⁹Si NMR on a Varian 500 MHZ NMR. ¹H NMR samples were prepared using 10-15 mg polymer dissolved in 550 μL TCE-d2 with a D1=10s, 16-32 scans and otherwise standard method. ²⁹Si NMR samples were prepared using 100 mg polymer and 500 μL TCE-d2 with 4 mM Cr(acac) 3 with a D1=5s, 256 scans and the QA-RINEPT method. Conversion of SiH by 1H NMR was determined by the change in integral of the SiH resonance at 3.95 ppm after extrusion compared to the unextruded sample and normalizing to the integral of the aliphatic resonances. All spectra were collected on a Varian 500 MHz spectrometer with a liquid N₂ cooled cryoprobe.

### FTIR-ATR

Infrared spectra were collected on a Perkin Elmer Frontier Fourier-transform infrared spectrometer (FT-IR) with attenuated total reflection (ATR) accessory (single bounce diamond/ZnSe). Samples were cut with scissors to reveal a clean interior surface, then placed into the accessory and held at a force where the peak absorbance is approximately 0.4 and 4-16 scans were collected depending on spectrum quality. Spectra was collected in at least triplicate to ensure representative sampling of the entire sample.

SiH conversion is the mol % of SiH bonds in the Polymer Source that become Si—OH bonds as a result of the oxidation reaction. SiH conversion was determined by normalizing the peak at 2920 cm⁻¹ and setting the baseline to zero at 942 cm⁻¹, the Si—H peak at 887 cm⁻¹ was then used to determine conversion, % SiH Conversion=100* (Absorbance at 887 cm⁻¹ after the oxidation reaction)/(Absorbance at 887 cm⁻¹ before the oxidation reaction).

1. A method of preparing a silanol-functional polyolefin, comprising:
combining, under thermal conditions to effect synthesis of a silanol moiety, starting materials comprising:
A) a silyl hydride-functionalized polyolefin,
optionally B) a solvent,
C) a peroxy acid,
optionally D) a neutralizing agent;
thereby forming a reaction mixture that under the thermal conditions produces the silanol-functional polyolefin having the silanol moiety.

2. The method of claim 1, wherein the silyl hydride-functionalized polyolefin includes a silyl hydride moiety of Formula I: 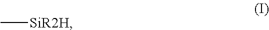
wherein each R is independently selected from the group consisting of alkyl groups of 1 to 4 carbon atoms and aryl groups of 6 to 10 carbon atoms.

3. The method of claim 2, wherein each R is a methyl group.

4. The method of claim 2, wherein silyl hydride-functionalized polyolefin includes 0.10 weight percent (wt. %) to 10 wt. % of the silyl hydride moiety of Formula I based on the total weight of the silyl hydride-functionalized polyolefin.

5. The method of claim 1, wherein the silyl hydride-functionalized polyolefin is selected from the group consisting of a silyl hydride-functionalized polyethylene and a silyl hydride-functionalized polypropylene.

6. The method of claim 1, wherein the silyl hydride-functionalized polyolefin is a branched silyl hydride-functionalized polyolefin.

7. The method of claim 1, wherein the thermal conditions to effect synthesis of the silanol moiety includes melt-blending the reaction mixture at a temperature of 100° C. to 180° C. for a duration from 30 seconds to 60 minutes.

8. The method of claim 7, wherein the method occurs in the absence of a solvent.

9. The method of claim 1, wherein the thermal conditions to effect synthesis of the silanol moiety includes dissolving the silyl hydride-functionalized polyolefin in B) the solvent of the reaction mixture.

10. The method of claim 9, wherein the thermal conditions to effect synthesis of the silanol moiety includes heating the reaction mixture at a temperature of 60° C. to 120° C. for a duration from one minute to 60 minutes.

11. The method of claim 1, further comprising separating the silanol-functional polyolefin from the reaction mixture.

12. The method of claim 1, wherein C) the peroxy acid is used in an amount of 1 to 3 molar equivalents of peroxy acid based on silicon bonded hydrogen content of A) the silyl hydride-functionalized polyolefin.

13. The method of claim 1, wherein the peroxy acid is selected from the group consisting of peracetic acid, meta-chloroperbenzoic acid, perbenzoic acid and combinations thereof.

14. The method of claim 1, wherein D) the neutralizing agent is present in the reaction mixture.

15. A silanol-functional polyolefin formed by claim 1.
